(19) United States
(12) Patent Application Publication
(10) Pub. No.: US 2011/0073737 A1
(43) Pub. Date: Mar. 31, 2011

(54) Christmas Magic Paper Tree Holder

(76) Inventor: Mon-Sheng LIN, Taipei (TW)

(21) Appl. No.: 12/352,089

(22) Filed: Jan. 12, 2009

(51) Int. Cl. F16M 13/00

(52) U.S. Cl. 248/346.03

(57) ABSTRACT

A Christmas magic paper tree holder having a hollow base, locating blocks radially inwardly extended from the inside wall of the hollow base, locating grooves respectively defined in between each two adjacent locating blocks and met at the center of the hollow base for the insertion of a bottom side of a Christmas magic paper tree in one of a series of angles.

### BACKGROUND OF THE INVENTION

1. Field of the Invention

The present invention relates to Christmas ornamental devices and more particularly, to a holder for holding a Christmas paper tree.

2. Description of the Related Art

According to a known Christmas magic paper tree positioning arrangement, as shown in FIG. 7, a Christmas magic paper tree holder A is set in a vessel B to hold a Christmas magic paper tree (not shown). The vessel B holds a magic fluid B1. The Christmas magic paper tree holder A has a flat base A1, and a plurality of locating blocks A2 upwardly protruded from the top side of the flat base A and defining therein intersected locating grooves A3. A user can insert the bottom side of a Christmas magic paper tree into the intersected locating grooves A3, enabling the installed Christmas magic paper tree to absorb the magic fluid B1 from the vessel B. The Christmas magic paper tree starts to grow magic flowers about 8˜12 hours after absorbed the magic fluid B1. According to this design, the Christmas magic paper tree holder A is directly placed in the vessel B. The vessel B has no any fastening means to secure the Christmas magic paper tree holder A firmly in place. The Christmas magic paper tree holder A and the attached Christmas magic paper tree may fall upon a vibration, an accidental impact, or a strong wind. Further, because the Christmas magic paper tree holder A is not fixed in position, the Christmas magic tree may be forced to change its angle by an external force.

### SUMMARY OF THE INVENTION

The present invention has been accomplished under the circumstances in view, it is one object of the present invention to provide a Christmas magic paper tree holder, which allows convenient adjustment of the positioning angle of the Christmas magic paper tree.

To achieve this and other objects of the present invention, a Christmas magic paper tree holder comprises a hollow base, a plurality of locating blocks radially inwardly extended from the inside wall of the hollow base, a plurality of locating grooves respectively defined in between each two adjacent locating blocks and met at the center of the hollow base for the insertion of a bottom side of a Christmas magic paper tree in one of a series of angles, and a positioning portion protruded from the periphery of the hollow base.

### BRIEF DESCRIPTION OF THE DRAWINGS

FIG. 1 is an oblique top elevation of a Christmas magic paper tree holder in accordance with the present invention.

FIG. 2 is an oblique bottom elevation of the Christmas magic paper tree holder in accordance with the present invention.

FIG. 3 is an exploded view of a Christmas magic paper tree kit according to the present invention.

FIG. 4 is an elevational assembly view of FIG. 3.

FIG. 5 is a sectional view showing an installation example of a Christmas magic paper tree in the Christmas magic paper tree holder.

FIG. 6 is a sectional view showing another installation example of a Christmas magic paper tree in the Christmas magic paper tree holder.

FIG. 7 is an exploded view, showing a Christmas magic paper tree positioning arrangement according to the prior art.

### DETAILED DESCRIPTION OF THE PREFERRED EMBODIMENT

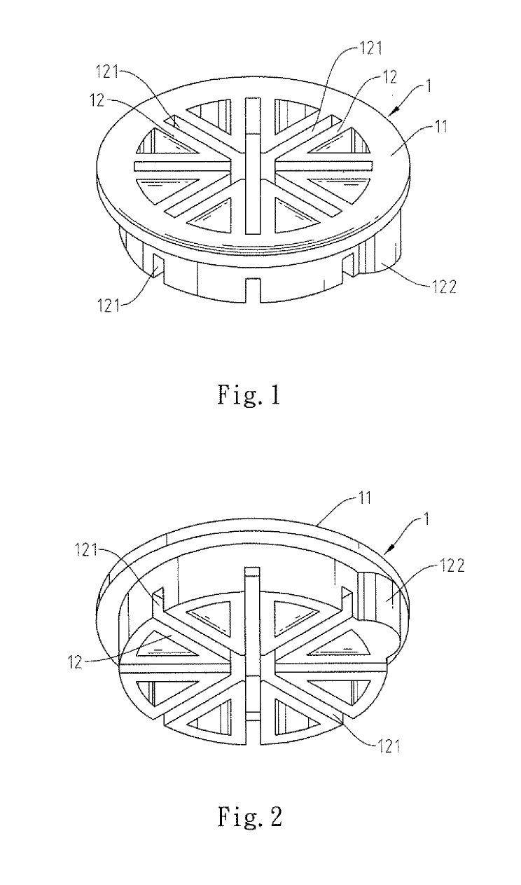

Referring to FIGS. 1 and 2, a Christmas magic paper tree holder 1 in accordance with the present invention comprises a hollow base 11, a plurality of locating blocks 12 radially extended from the inside wall toward the center of the hollow base 11, a plurality of locating grooves 121 respectively defined in between each two adjacent locating blocks 12 and met at the center of the hollow base 11, and a positioning portion 122 protruded from the periphery of the hollow base 11.

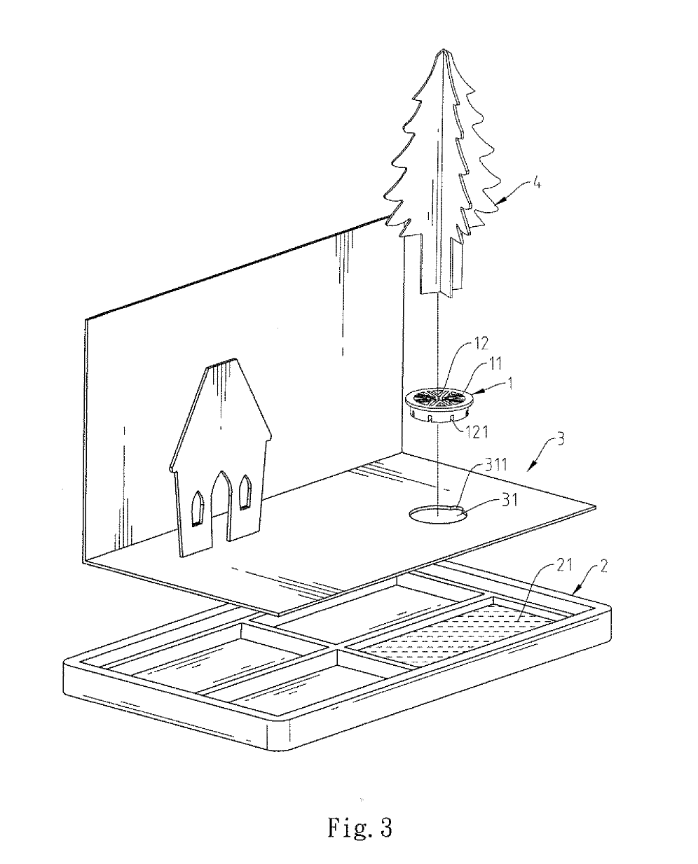

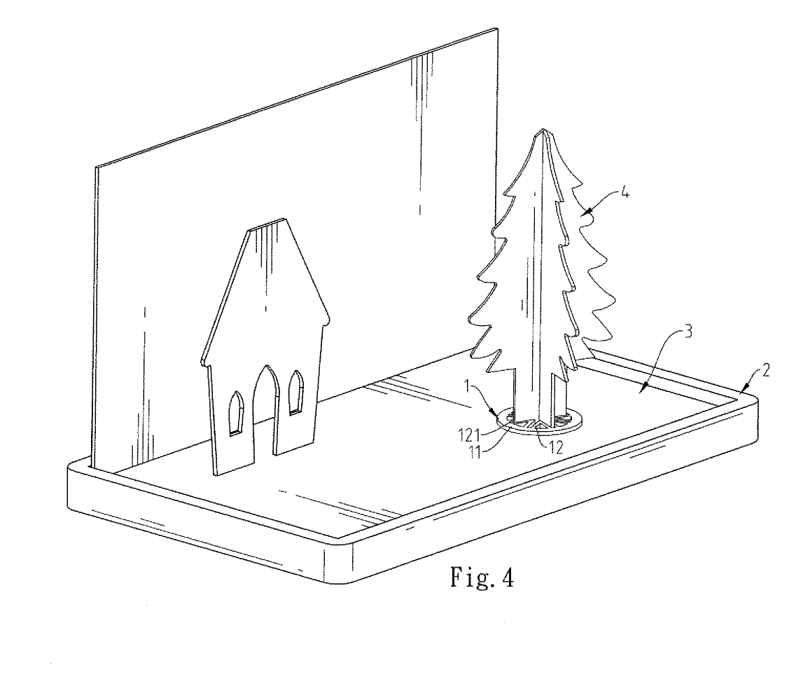

Referring to FIGS. 3 and 4 and FIG. 2 again, when in use, pour a magic fluid 21 in a pan 2, and then place a floor panel 3 on the top side of the pan 2 without touching the magic fluid 21 and then insert the Christmas magic paper tree holder 1 in a through hole 31 on the floor panel 3 to engage the positioning portion 122 into a notch 311 on the border area of the through hole 31. At this time, the user can insert the bottom side of a Christmas magic paper tree 4 into the locating grooves 121 of the Christmas magic paper tree holder 1, enabling the Christmas magic paper tree holder 1 to absorb the magic fluid 21 from the pan 2.

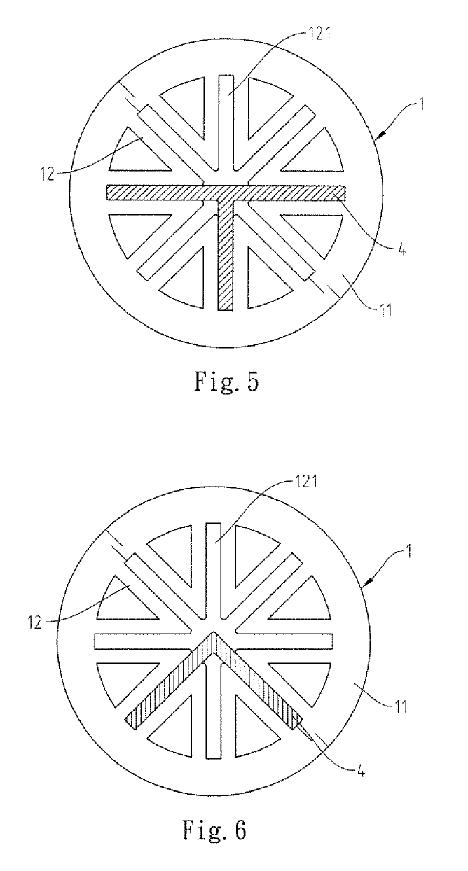

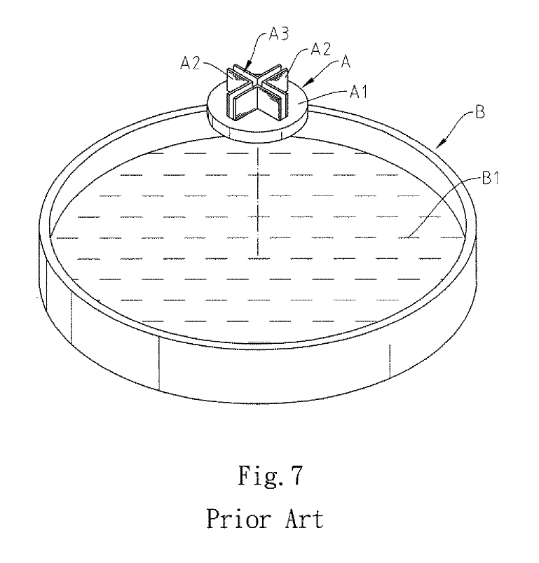

Referring to FIGS. 5 and 6, the locating grooves 121 of the Christmas magic paper tree holder 1 extend radially from the center to the inside wall of the hollow base 11 in communication with one another. Therefore, the user can selectively insert the bottom side of the Christmas magic paper tree 4 into the locating grooves 121 of the Christmas magic paper tree holder 1 in one of a series of angles.

Further, the Christmas magic paper tree holder 1 is made in a single piece.

A prototype of Christmas magic paper tree holder has been constructed with the features of FIGS. 1˜6. The Christmas magic paper tree holder functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A Christmas magic paper tree holder, comprising a hollow base, a plurality of locating blocks radially extended from an inside wall of said hollow base toward the center of said hollow base, a plurality of locating grooves respectively defined in between each two adjacent ones of said locating blocks and met at the center of said hollow base for the insertion of a bottom side of a Christmas magic paper tree.

2. The Christmas magic paper tree holder as claimed in claim 1, further comprising a positioning portion protruded from the periphery of said hollow base.

3. The Christmas magic paper tree holder as claimed in claim 1, which is made in a single piece.
